(19) United States
(12) Patent Application Publication
(10) Pub. No.: US 2009/0037307 A1
(43) Pub. Date: Feb. 5, 2009

(54) ONLINE ORIGINATION MACHINE

(75) Inventor: Robert J. Ortega, Moravian Falls, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/832,600

(22) Filed: Aug. 1, 2007

(51) Int. Cl. G06Q 40/00

(52) U.S. Cl. 705/35

(57) ABSTRACT

A system that facilitates an identification of potential investment banking opportunities and matches those identified potential banking investment opportunities to investment banking products is disclosed. More opportunities are acted on and more deals are closed than without the subject innovation. Additionally, a user interface facilitates product match and product configuration. After a product is configured and matched to an opportunity, a presentation is generated to ‘pitch’ to a customer.

### TECHNICAL FIELD

The subject specification relates generally to proactive opportunity identifying methods and apparatus and in particular, to systems and methodologies that automatically identify potential opportunities and automatically refer, match and/or configure at least one product that at least partially matches the identified opportunity.

### BACKGROUND

There are many investment bankers (IBs) in the United States (US) economy wherein a plurality of merger and acquisition deals (M&A) are transacted each year involving different transaction amounts. For example, in last two years there were approximately $74.5 billion worth of US M&A deals or other ‘financial deals’ with transaction amounts greater than $250 million. As used herein, a financial deal can refer to M&A deals, IPO deals, and any other deals that involve commercial or other investment banking. To meet revenue or growth expectations, many publicly owned companies are forced to merge or acquire other companies.

Besides M&A deals, there are also many debt and equity issues, including new issuances bonds, and of stock as either an initial public offering (IPO) or an issue of additional amounts of an established stock each year with many new issues having a principal amount of $250 million or less in the last two year period. One of the most celebrated events in American business is the initial public offering (IPO). Many see it as a transforming event that typically creates wealth, sometimes almost unbelievable wealth, ensures a company's near-term survival, and paints a company with the aura of elevation into the business ‘big leagues.’

Between M&A deals and issuances of stock, there are many other opportunities for investment bankers. However, many M&A deals may be deemed too small and otherwise not worthy of taking the time and trouble to try to obtain those deals. One reason that small M&A deals are sometimes left undone are the costs of the transactions, such as research cost, due diligence costs, legal fees, traveling expenses, and/or taxes. Additionally other deals that may have taken place do not get noticed because the agents (people or company or any entity) do not know about the opportunity, only partial knowledge is available, or a decision to err on the side of caution is made.

Furthermore, some opportunities are missed by even top executives with the sharpest acumen. Another reason for a deal not going through may be based on a personality mismatch or clash. Many times potential IPOs do not occur because aside from paying the underwriters, companies going public have to pay lawyers, accountants, printers, and in general the totality of the transaction costs just does not merit the IPO. Other costs can involve investor relations' professionals.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation, in one aspect thereof, provides for a system and/or method that facilitates identification of potential investment banking opportunities and matching those identified potential banking investment opportunities to investment banking products. In another aspect of the subject innovation, a method includes receiving information regarding a potential investment banking opportunity and automatically, in a computer environment, performing at least one of matching the potential investment banking opportunity with an already established investment product and configuring a new investment product to at least partially match the received potential investment opportunity.

Accordingly, more opportunities can be acted upon and more deals (e.g., smaller-sized deals) can be closed than without the subject innovation. Additionally, a user interface facilitates product matching and product configuring. After a product is configured and matched to an opportunity, a presentation can be generated. A presentation can then be scheduled to be ‘pitched’ (or presented) to a customer. After the initial sales pitch, feedback can be gathered, additional information can be gathered, and rescheduling for a subsequent sales pitch can be made if it is desirable. The herein described user interface facilitates accommodation to customers even if they are relatively ‘small’ in financial size. Rather, if desired, the opportunity or customer can be referred to other providers of financial services. Whether the decision is to develop a deal with a customer or is to refer the customer to another financial services provider, either way a follow-up can occur. Accordingly, the innovation addresses all merger and acquisition (M&A) deals, regardless of size. Additionally, the innovation addresses most equity and debt deals, regardless of size.

The subject innovation provides for systems and methods that employ a user interface that includes increased efficiencies such that smaller deals can be identified. It is to be understood that the ‘smaller’ deals refer to those that would have oftentimes been referred elsewhere in the past due to the relatively small size in comparison to larger deals. In accordance with the innovation, increased efficiency for the herein described methods and apparatus facilitate the smaller deals to be kept and processed efficiently. As described herein, the innovation increases the efficiency ratio (e.g., profit margin). Additionally by keeping smaller deals, the contractual network is extended enhancing the ability to learn of the more additional market opportunities and referrals. In addition to the revenue generation benefits of the herein described methods and systems and apparatus, the innovation helps to mitigate risk by ensuring that a process is in place that survives after any intellectual capital leaves the bank as a result of attrition. The system would also provide reduction in execution risk by delivering the ability to track/monitor each step of the deal process.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an opportunity system in accordance with an aspect of the subject innovation.

FIG. 2 illustrates a block diagram of an opportunity system including a potential opportunity identifier component and a filtering component in accordance with an aspect of the subject innovation.

FIG. 3 illustrates a method in accordance with an aspect of the subject innovation, the method is for identifying potential opportunities in accordance with an aspect of the subject innovation.

FIG. 4 illustrates a block diagram of a system that identifies potential opportunities including a potential opportunity identifier component and a prioritization component in accordance with an aspect of the subject innovation.

FIG. 5 illustrates a logic flow and includes both acts performable by a person or persons and components operating in computing environments where data, such as, for example, but not limited to, news, information about people, transcripts, blogs, sites, and/or any other sources is available in accordance with an aspect of the innovation.

FIG. 6 is a block diagram of a system configured to manage content with a content management component then in turn manages a pipeline with a pipeline management component and manages tracking expenses with an expense tracking component, which results in the management of workflow/business process via a workflow/business process management component in accordance with an aspect of the innovation.

FIG. 7 illustrates a schema illustrating the workflow/business process management component and the content management component in a different setting then seen in FIG. 6 in accordance with an aspect of the innovation.

FIG. 8 illustrates a user interface including users that can be investment bankers (IB) as set fourth at one place and/or customers as set fourth at another place in accordance with an aspect of the subject innovation.

FIG. 9 illustrates a brief general description of a suitable computing environment wherein the various aspects of the subject innovation can be implemented.

FIG. 10 illustrates a schematic diagram of a client—server-computing environment wherein the various aspects of the subject innovation can be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components. Furthermore, the terms “web page,” “page” and “website,” are generally used interchangeably herein and relate to a resource of information that can be suitable for the World Wide Web and can be accessed through a web browser.

Additionally, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

There are a few separate concepts involved in the subject innovation. Potential investment banking opportunities are found through the use of an investment banking opportunity net. The finding institution does some opportunities, other opportunities are sent to an investment banking opportunity referral network, such that an institution other than the finding institution can do the opportunities. Together the concepts disclosed herein create an investment banking origination machine that also can include investment banking service request component. A software platform is useful for investment banking origination. The software machine can be made up of several software engines, such as rules based software engines. The subject innovation enables execution risk reduction, and facilitates making M&A deals and “new issues” deals—including both debt and equity financial products or services. Investment banking origination—getting the mandate to lead or participate in an investment banking deal is also facilitated by the subject innovation.

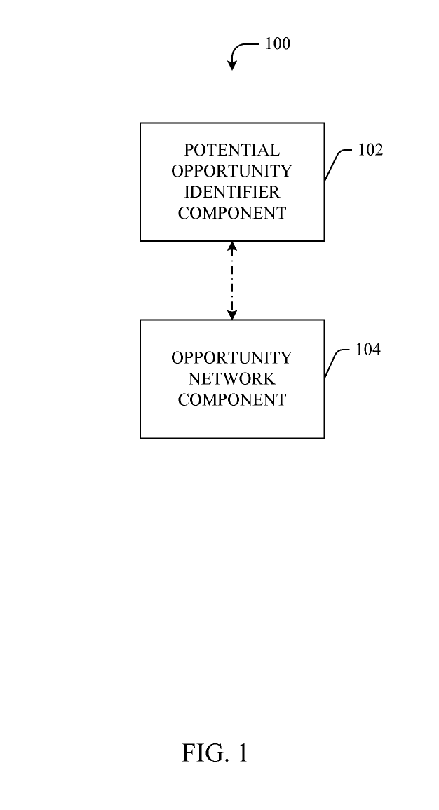

FIG. 1 illustrates a block diagram of an opportunity system 100 in accordance with an aspect of the subject innovation. The system includes a potential opportunity identifier component 102 that is operationally coupled to an opportunity network component 104. In use and in one embodiment, the potential opportunity identifier component 102 identifies a potential IB or other investment opportunity such as an M&A (merger and acquisition) deal or an upcoming issuance of stock. As used herein, IB refers to all investment banking including corporate investment banking and commercial investment banking, wherein the terms “corporate investment banking” and “commercial investment banking” are employed interchangeably herein.

After the potential opportunity identifier component 102 identifies an investment opportunity, it notifies the opportunity network component 104 of that identified opportunity. In one embodiment, the opportunity network component 104 includes the ability to communicate with communication sources that can inform people or computers of the opportunity either via print media, radio media, television radio, transcripts, blogs sites, email, text messaging, instant messaging, the Internet, etc. The people receiving the information could be most anyone such as a subject matter expert, people skilled in the presentation of information to go sell or pitch the opportunity to a group or a person that might be interested in receiving the opportunity. Generally, the subject innovation in one aspect applies software and/or components to achieve more deal automation to increase the number of deals being addressed and the classes of deals being closed, e.g., more smaller deals.

Investment bankers will find useful an automated origination machine. The origination machine can be described as a state machine such that it is a collection of software that goes from one state to another state and uses certain rules engines for different stages. In one embodiment, the first part is an ‘opportunity net’ which is analogous to a fisherman's net but, instead of catching fish, the opportunity net catches opportunities. One can think of this as an ‘opportunity radar’ or an ‘opportunity network.’ In regards to the ‘opportunity network’ or ‘radar’, it is envisioned to be a combination of software and people working in a network model to identify or capture potential investment banking opportunities. The analogy is an arrangement of regular nets or strainers that capture potential opportunities—a systematic mechanism to catch wind of potential investment banking opportunities. The way that this would work in the system is that the software will be listening and searching for potential opportunities using a set of criteria or rules. The system also allows individuals to input potential opportunities via a web based form. The software will search across email, blogs, web sites, call reports, news feeds, credit agencies, voice transcriptions to text, and other relevant sources such as SEC and patent filings. This whole part of the system is about capturing potential investment banking opportunity.

Once the potential opportunities are captured, the opportunities will be qualified via a rules based preliminary analysis. In order to perform efficiently at start up of the origination machine, financial statement data would be captured in XBRL format or transformed to XBRL format or other consistent format. Having the data in a common format allows the system to use the same code to perform analysis for different opportunities. The rules based qualification process is a filter. The opportunities that make it through the filter can have further analysis performed on them and typically an analysis engine is applied to determine if these will be deals or not. In one embodiment, to assess if the potential opportunity meets a predetermined criteria for a group opportunity, the decision may be based on rules. If the opportunity does not qualify for the investment bank, the system can refer the opportunity internally or externally by using the rules based referral engine. The system tracks every step via a workflow engine. The investment bank can ask referral partners to use a simple software based tracking tool as part of the system so that investment bank can ensure that deals are not dropped and follow up accordingly. Members of the ‘investment banking referral network’ can use the system and the system allows the network supervisor or the entity that establishes the network to follow up on each opportunity. In other words, an analysis engine could be a rules engine such that certain rules are applied to automatically determine if the potential opportunities will become deals or not or who will do the deal.

In processing potential opportunities, the innovation can employ several engines, one of which can be an analysis engine. As described supra, prior to employing the analysis engine, the innovation can employ an opportunity capture engine (e.g., opportunity ‘net’). A third engine is a referral engine that means that if one runs the rules engine and identifies deals that do not meet defined criteria for the finder of the deal, then the finder can refer these potential opportunities to one or more partners (such as for example a small investment bank). A product matching engine can be engaged to select a product or a set of products for a given financial opportunity. The features, functions and benefits of each of these engines will become more apparent upon a review of the figures and description that follows. The system has the option to perform additional analysis before referring the opportunity or it can simply refer the opportunity based on the preliminary analysis. The system can also refer the opportunity with a financial product recommendation, including product configuration (specific terms, structure, pricing, etc).

FIG. 1 illustrates an example of an ‘origination machine’ that is a power-plant for investment banking deal origination. The number of deals per month increases significantly employing an existing investment baking team. There are cultural, process improvement, and discipline issues that go hand in hand with achieving improved results. The machine is a hybrid of technology and humans following a process in which technology can help organize, monitor, measure and integrate. The herein described methods and apparatus are in one embodiment a software based investment banking origination machine. The innovation employs the following software components, also described below: a self-service web site with assisted web site options, a workflow engine, a rules engine, a product matching engine, a product configuration engine, a presentation generation engine, and a scheduling engine. Typical products include brokerage services such as the trading of stocks and bonds and other investment vehicles such as derivatives, fixed income investments, foreign exchange investments, commodity investments, and equity securities as well as the raising of funds, both in debt and equity. Products also include funds for investing such as pension funds, mutual funds, and hedge funds and mortgages such as commercial mortgages. The innovation is employed for increasing investment banking deals, increasing deal process efficiency, reducing deal process execution risk, and increasing deal profit.

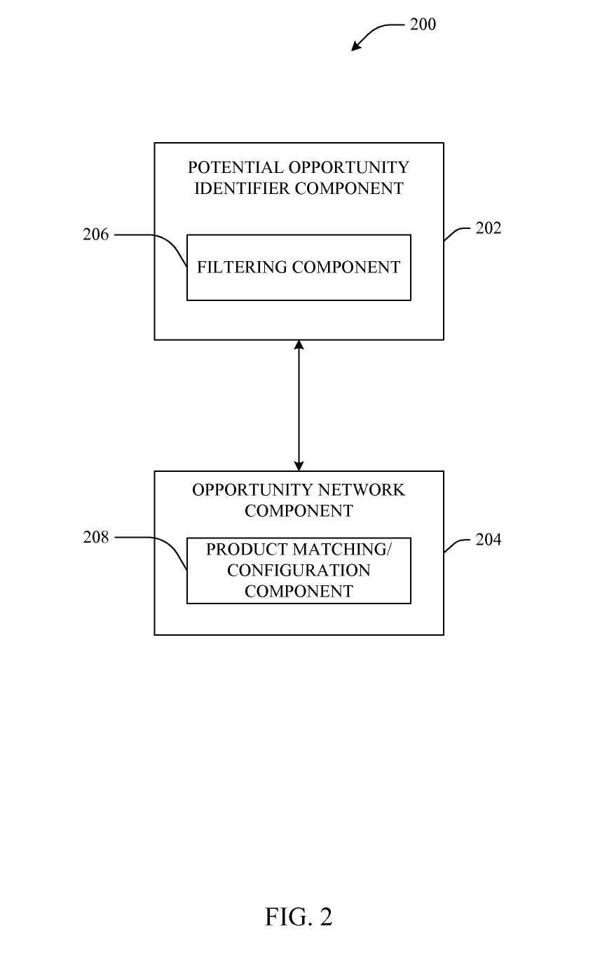

As shown in FIG. 2 described infra, a filter may be positioned between the opportunity network component 104 and the potential opportunity identifier component 102 to filter opportunities depending on factors such as an intimate understanding of the data, a due diligence of the company, a due diligence of the industry, a due diligence of competition, any trends of the product type, socio/political trends, data correlation trends, or any analysis a manufacturer may have that involves how good their opportunity can be ranked.

FIG. 2 illustrates a block diagram of an example opportunity system 200 in accordance with an aspect of the subject innovation. The system 200 includes a potential opportunity identifier component 202 and an opportunity network component 204 operationally coupled to the potential opportunity identifier component 202. A filtering component 206 can be included within the potential opportunity identifier component 202. In addition, a product matching/configuration component 208 can be included within the opportunity network component 204.

In use and in one embodiment, the potential opportunity identifier component 102 identifies a potential investment opportunity such as an M&A deal or an upcoming issuance of stock. For example in one embodiment, a search algorithm is used to locate potential opportunities. Broadly speaking, a search algorithm is an algorithm that takes a problem as input and returns a solution to the problem, usually after evaluating a number of possible solutions. Most of the algorithms studied by computer scientists that solve problems are variations of search algorithms. The set of all possible solutions to a problem is often referred to as the ‘search space.’ Brute-force search or ‘naïve’/uninformed search algorithms use the simplest, most intuitive method of searching through the search space, whereas informed search algorithms most often use heuristics to apply knowledge about the structure of the search space in an attempt to reduce the amount of time spent searching.

After the potential opportunity identifier component 102 identifies an opportunity, it makes the opportunity network component 104 aware of that identified opportunity (or group of opportunities). In one embodiment, the opportunity network component 104 includes the ability to communicate with sources that can inform people or computers of the opportunity either via print media, radio media, television radio, transcripts, blogs sites, email, text message, instant message, the Internet, etc. The people receiving the information could be subject matter experts, people skilled in the presentation of information to go sell or pitch the opportunity to a group or person that might be interested in receiving the opportunity. Factors used in the opportunity include size of market, size of company, sector of economy, type of industry, historical sales data, sales forecasts or location. The location can be city, county, state, country, or regions thereof.

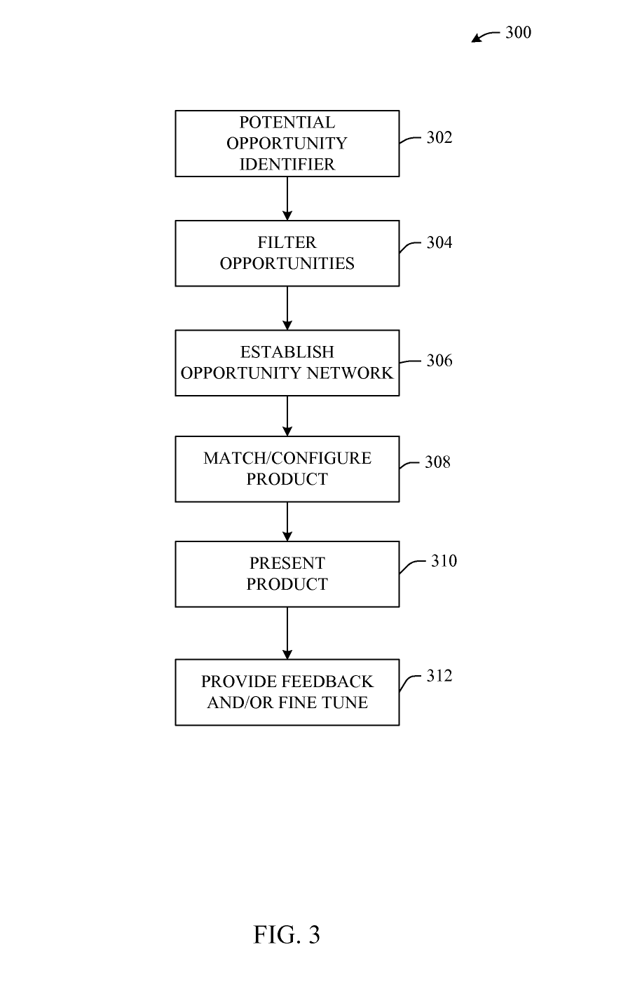

FIG. 3 illustrates a method 300 for identifying potential opportunities including a potential opportunity identifier act 302 and a filtering act 304. After the potential opportunities were originally identified and filtered at 302 and 304 respectively, they can be combined at act 306 to form an opportunity network. This opportunity network can then be matched to products and/or configurations of products on a deal by deal basis at act 308. After product opportunities are matched at act 308 then the proposed product can be presented to a possible customer at act 310. Although potential opportunity identifier act 302 and filtering act 304 are termed acts it is contemplated that each could be embodied with a structured component as in a computer system as described below.

The customer may agree to the product as is or may provide feedback allowing a fine tuning or further configuring of the proposed product at act 312. The filtering component 304 may filter by ranking as explained above or may filter on a go no-go basis as explained above with the baskets of potential opportunities and non-potential opportunities. Additionally, the product matching/configuring act 308 can encompass a ranking of products to opportunities as opposed to just a go no-go decision making process. In disparate aspects, the presenting act 310 can be automated or can be manual.

In one embodiment a large portion of method 300 can be accomplished via the Internet. Method 300 may be implemented employing XBRL which stands for eXtensible Business Reporting Language. As will be appreciated, XBRL is one of a family of ‘XML’ (extensible markup language) languages which is becoming a standard means of communicating information between businesses and on the Internet. XBRL has been developed by an international non-profit consortium of approximately 450 major companies, organizations and government agencies. It is an open standard, free of license fees. It is already being put to practical use in a number of countries and implementations of XBRL are growing rapidly around the world. It is contemplated that the benefits of the innovation accrue to embodiments that employ a language other than XBRL.

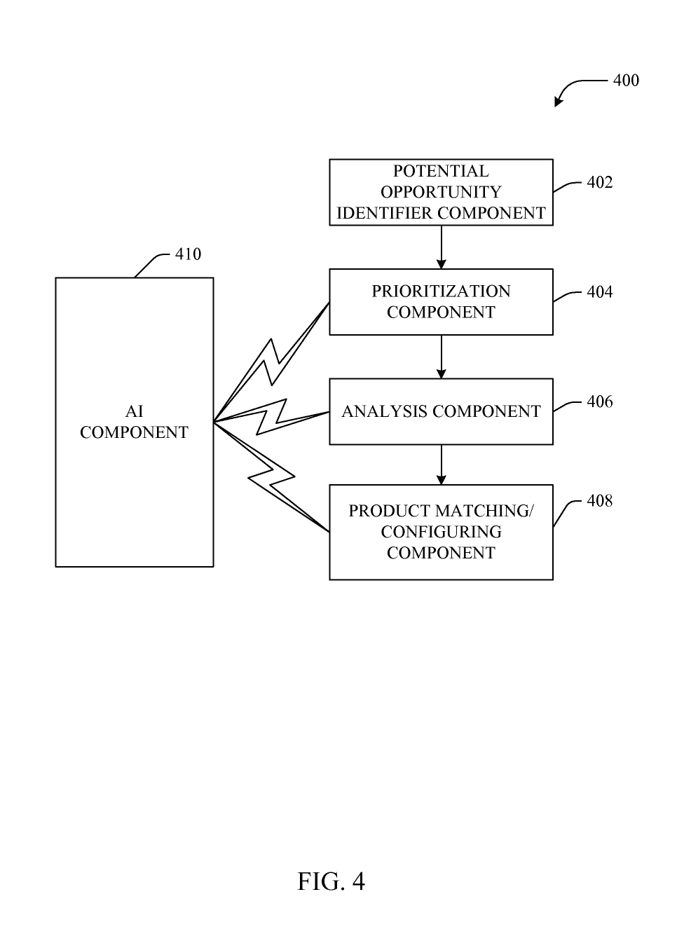

FIG. 4 illustrates an example system 400 that identifies potential opportunities, wherein the system 400 can include a potential opportunity identifier component 402 and a prioritization component 404. System 400 can also include an analysis component 406 and a product matching/configuring component 408 that can perform a ranking of products to opportunities (e.g., best partial match) as well as a go no-go decision making process (only perfect matches). The prioritization component 404 can prioritize based on timeliness (e.g., customer needs a quick deal), dollar amount (both current deal value and/or cumulative value of all deals), among other ranking factors. The analysis component 406 can perform an analysis to verify that the customer can qualify for the product. In one embodiment, method 400 includes the employ of artificial intelligence (AI) component 410. The AI component 410 can be employed to facilitate inferring and/or determining when, where, how to aggregate, data mine, rank and/or sort opportunities, deals, transactions etc. Such inference results in the construction of new events or actions from a set of observed events and/or stored event data, whether or not the events are correlated in close temporal proximity, and whether the events and data come from one or several event and data sources.

The AI component 410 can also employ any of a variety of suitable AI based schemes in connection with facilitating various aspects of the herein described innovation. For example, and in the context of a Structured Query Language (SQL) server/client where the client is a customer of the bank and the bank is using a server, a process for learning explicitly or implicitly how a value related to a parsed SQL statement should be replaced can be facilitated via an automatic classification system and process. Classification can employ a probabilistic and/or statistical-based analysis (e.g. factoring into the analysis utilities and costs) to prognose or infer an action that a user desires to be automatically performed.

For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority. Part of this is a website, but the website is just one way to collect a set of opportunities by allowing customers to directly put in a request. Once the request is put in, the workflow engine picks up the request and tracks it through the workflow as described herein.

There are other ways in which opportunities are captured intelligently and these other ways include doing text analytics against logs, against websites, against vendor provided news sites like the Wall Street Journal and Bloomberg and other places looking to surface certain events that indicate momentum toward an opportunity. Basically herein described is doing content analysis to search for new potential investment banking opportunities. These additional mechanisms of identifying opportunities are to be included within the scope of this disclosure and claims appended hereto.

One aspect is to look for keywords for things like triggers, and correlate the data. It will be understood that IBs most often have data access, for example, to Dun & Bradstreet and can perform structured queries such as in SQL.

Although the potential opportunity identifier component 402 is illustrated within the content of the origination machine (FIG. 1), it can be a stand-alone component. In addition, the investment banking products matching and configuration engine can be its own stand-alone engine. Some embodiments employ machine learning, for example an AI component 410 looking at client size, or timing looking for M&A deals prior to an announcement of the merger or acquisition.

As will be readily appreciated from the subject specification, the subject innovation can employ classifiers that are explicitly trained (e.g. via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

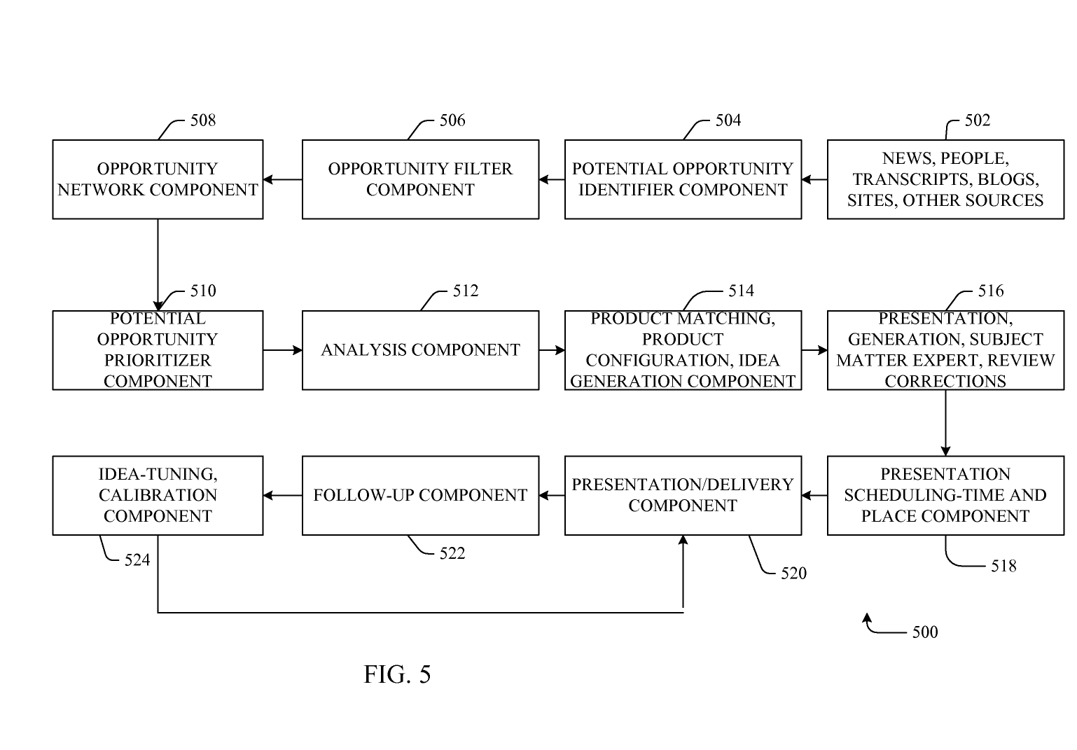

FIG. 5 illustrates a logic flow 500 and includes both acts performable by a person or persons and components operating in computing environments where data, such as, for example, but not limited to, news, information about people, transcripts, blogs, sites, and/or any other sources is available at 502 which could be acts or computerized. Either automatically or manually, the data is sent to a potential opportunity identifier component 504. An opportunity filter component 506 is available to filter opportunities by identifying potential opportunities that are provided to an opportunity network component 508. A potential opportunities prioritizer can order the opportunities. The ordering can be based on dollar value, timing, other factors and combinations thereof. An analysis component 512 can perform an analysis of the prioritized potential opportunities.

The analysis may be based on an intimate understanding of the opportunity, based on a due diligence investigation of the company, based on a due diligence investigation of the industry, and/or based on a due diligence investigation of the competition. The analysis may take into consideration trends including industries trends and socio-political trends. Additionally, there can be some data correlation undertaken. The analysis may include text analytics and text mining to understand various themes and context based information extraction and text modeling in order to seek potential opportunities and in order to prioritize the opportunities and by the analysis component 512 to further narrow the list. In one embodiment, an initial analysis is automated and then a second analysis is performed manually. However, in another aspect the analysis can be first manual then automated and finally manual again. It is to be understood that those can be reversed for an automatic, manual, automatic ordering. A product matching, product configuration, and/or idea generation component 514 is available to create ideas, to form products and to coordinate products.

At 516, a presentation may be generated, the presentation may be subject to a review by an expert in that subject matter area, and corrections can be implemented internally. At 518, a presentation is scheduled with a potential customer, both the time and place are scheduled. The presentation is delivered at 520. A later follow-up can be done at 522. The idea can be fine-tuned or calibrated at 524, and provided back to the customer at 520. This final part of tuning and re-presenting can take several iterations as appropriate. The system also offers rules based prioritization of opportunities. Prioritization can happen before any state of the system such as analysis, referral, product matching, product configuration, presentation generation, or pitch scheduling.

Additionally, at least some of the processes illustrated in FIG. 5 can be through an internal portal or an external portal. The internal portal can be utilized as a unified presentation layer with consistent graphical interface and with an intelligent persona. In another embodiment, an external investment banking portal provides a self-service interface with assisted modes in addition to the ability to upload financial information.

Furthermore, in one embodiment and with reference to 516, the presentation logic includes dynamic content generation. As illustrated in FIG. 5, the innovation can facilitate the reduction or elimination of lost revenue due to deals being deemed too small. By automating the matching of opportunities with products, the innovation allows for revenue optimization in a human resource constrained environment. Accordingly, much smaller deals can be captured which generate less revenue than previously was the minimum level. The logic flow illustrated in FIG. 5, which is representative of a well tuned IB origination machine, can be a web-based secure system that easily allows a banking entity to capture and manage leads as well as allow the business to capitalize on opportunities of all sizes by leveraging on technology that facilitates qualification configuration presentation and referral of deals.

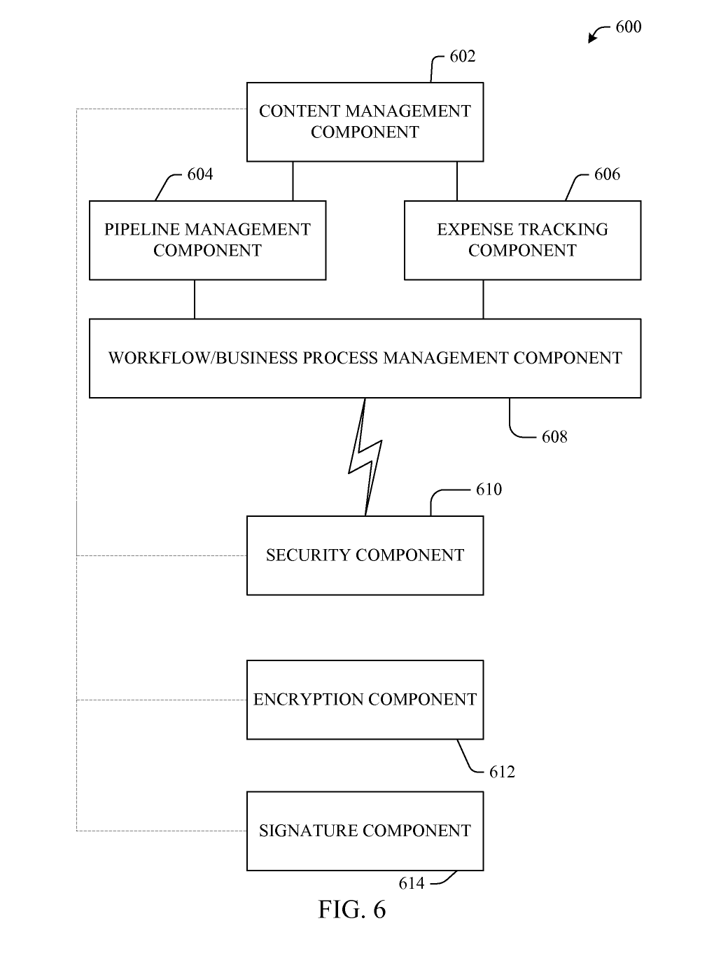

FIG. 6 is a block diagram of a system 600 configured to manage content with a content management component 602 then in turn manages a pipeline with a pipeline management component 604 and manages tracking expenses with an expense tracking component 606, which results in the management of workflow/business process via a workflow/business process management component 608. It is to be understood that the ‘pipeline’ refers to a pipeline of deals. Coupled to at least one of the content management component 602 and the workflow/business process management component 608 is a security component 610 that can be used to cryptographically protect (e.g., encrypt) data as well as to digitally sign data, to enhance security and decrease or eliminate unwanted, unintentional or malicious disclosure. In operation, the security component 610 can communicate data to/from any component herein described and to any other component herein described.

Once a deal is identified, it is desirable in some situations to maintain the privacy of the deal. Additionally, regarding M&A deals with publicly owned companies, rules require careful disclosure of potential deals, because sometimes just the news of a possible deal can cause stock prices to change. Accordingly, an encryption/decryption component 612 can be used to cryptographically protect data during transmission as well as while stored. The encryption component 612 employs an encryption algorithm to encode data for security purposes. The algorithm is essentially a formula that is used to turn data into a secret code. Each algorithm uses a string of bits known as a ‘key’ to perform the calculations. The larger the key (e.g., the more bits in the key), the greater the number of potential patterns can be created, thus making it harder to break the code and descramble the contents of the data.

Most encryption algorithms use the block cipher method, which codes fixed blocks of input that are typically from 64 to 128 bits in length. As described above, a decryption component 612 can be used to convert encrypted data back to its original form. Upon retrieval, the data can be decrypted using a private key that corresponds to the public key used to encrypt.

A signature component 614 can be used to digitally sign data and documents when transmitting and/or retrieving from the electronic storage source. It is to be understood that a digital signature can essentially guarantee that a file has not been altered, similar to if it were carried in an electronically sealed envelope. The ‘signature’ is an encrypted digest (e.g., one-way hash function) used to confirm authenticity of data. Upon accessing the data, the recipient can decrypt the digest and also re-compute the digest from the received file or data. If the digests match, the file is proven to be intact and tamper free. In operation, digital certificates issued by a certification authority are most often used to ensure authenticity of a digital signature.

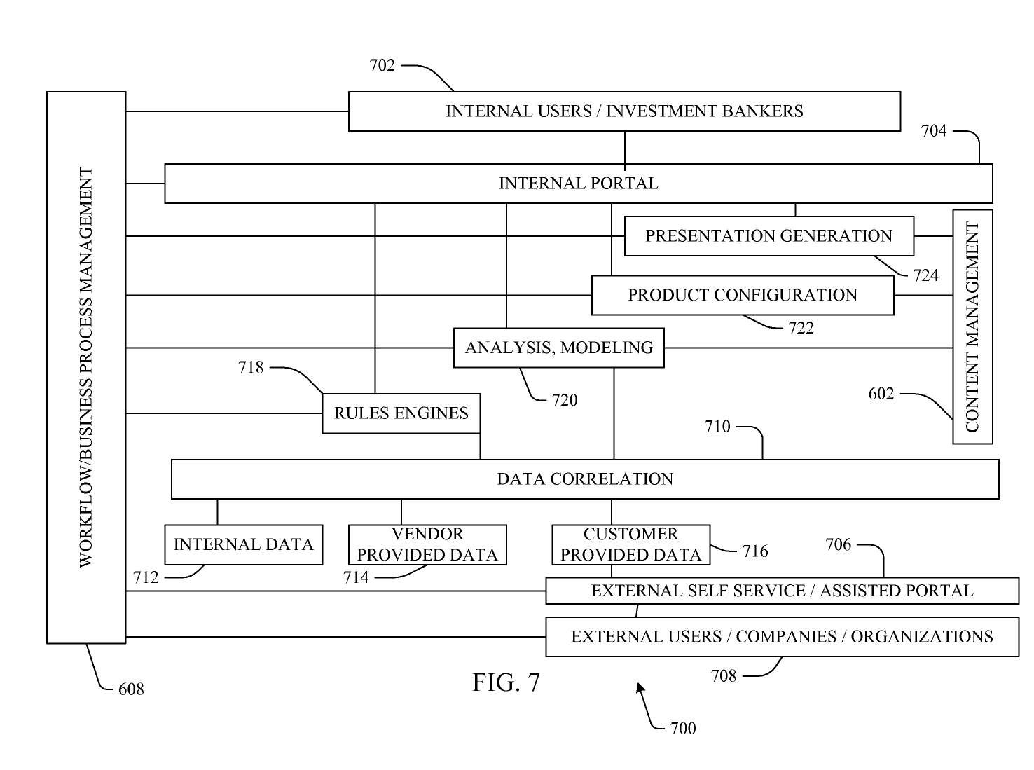

FIG. 7 illustrates a schema 700 that depicts the workflow/business process management component 608 and the content management component 602 in a slightly different setting as set forth in FIG. 6. The system can be offered as platform to members of the referral network and members can use their own criteria/rules to drive the system. In one aspect, a characteristic of the system is the ability for end users or subject matter experts to create, configure and manage rules used by each engine in the system. FIG. 7 illustrates that a plurality of internal users/investment bankers are able to employ an internal portal 704. An external portal 706 allows for the self-service employ of customers and in one embodiment is there to assist the user. The users may be company's organizations, individuals, or users as set forth at 708. Data correlation can be done at 710 using internal data 712, vendor provided data 714, and/or customer provided data 716.

Regardless if any data correlation took place, a rules engine 718 provides for a basic layer for performing analysis and modeling at 720. After any analysis and modeling regarding the activities and products then a product configuration tool or component 722 can best match the best product with an optimized configuration with the incoming opportunity(ies).

Lastly, a presentation generation component 724 generates a presentation to facilitate making a pitch for sale of the product to the opportunity. While not specifically described with respect to FIG. 7 it should be appreciated that a security component (e.g., 610 of FIG. 6) can be used to protect the data flow illustrated in FIG. 7. Additionally, an encryption component (e.g., 612 of FIG. 6) can be used to cryptographically protect data during transmission as well as while stored. Also, hashing techniques could be employed with some of the data transfer and records maintenance, for example, to ease bandwidth requirements.

In operation, for each financial opportunity that the bank will pursue, the potential opportunity is provided to a product matching engine (e.g., 514 of FIG. 5) that compares the opportunity against the products that the bank has available. Additionally, the product matching engine (e.g., 514 of FIG. 5) can search for a combination of products that satisfies the needs of the customer.

The presentation generation engine (e.g., 514 of FIG. 5) can be employed to automatically generate a presentation that sets forth the bank's understanding of the target company, the bank's understanding of the industry, and the bank's understanding that this product has a potential for the target company's needs. The presentation generation component 514 creates an individualized sales document for each of the matches. There is also an engine referred to as a product configurator engine (e.g., 514 of FIG. 5) that can facilitate further personalization.

In operation, the product matching engine can link (or identify) one or more products in view of the potential opportunities. The product configurator engine can personalize the products such as to the terms of the deal, and to identify how long it may/will take to complete the deal. In other words, first the product is matched to a potential opportunity, or a set of products are matched to the potential financial opportunity, then the products are configured. Once products are configured, a presentation (or pitch) can be generated, such as in a PowerPoint, and sent to a user for review.

As described supra, the innovation enables automatic deal identification and drafting of a draft presentation for an investment banker to review and finalize into a formal presentation. Alternatively, the reviewer can also discard the presentation. Further, the innovation enables recordation of participant users that view and/or approve the presentation. Once the proper people have approved the final presentation, the presentation information is sent to a scheduling engine such as component 518 of FIG. 5, which can also include a rules-based engine (or AI-based engine). The scheduling engine will determine an appropriate investment banker based upon deal criteria (e.g., specific industry). Thereafter, the scheduling engine can trigger an appointment to give (or 'pitch) the presentation to the potential customer.

It will be appreciated that the scheduling engine will be aware of an investment banker that covers a particular industry that a company is in, and that this investment banker is traveling to a certain location or going be at a particular meeting or a particular conference in a particular location. This information together with other attendee information can be obtained by the scheduling engine, e.g. via PIM (personal information manager) data analysis. In other words, a scheduling engine can have knowledge of different people's schedules and facilitates thereby saving time and money in performing the scheduling of the presentation. Once a tentative schedule is created, e-mails can be automatically sent with meeting requests to the intended attendees of the presentation.

In one aspect, the presentation engine such as component 518 of FIG. 5 has schedules of people and uses this knowledge of the people's planned travels or lack of traveling to minimize or reduce travel cost associated with a presentation. After the presentation is made, a feedback loop is entered in which someone or an automated process (e.g. an automated tickler or email system) follows up with the intended customers and can obtain feedback. Additionally, based on the received feedback, additional presentations can be scheduled. The additional presentations can include products with differences to the products than what was originally shown or presented. In one aspect, there is a workflow engine that monitors the flow to achieve timely results. In one embodiment, the workflow engine is the workflow/business process management component 608.

In a particular embodiment, the innovation can be front-ended by an external site. Here, the opportunity radar catches opportunities by having a website that allows customers to financial institution know details of a request. Therefore, a small company seeking to engage an investor or to borrow one hundred million dollars, can provide details such as “this is my contact information,” “this is the sector I am in” and “I think that the best way to make this money is to do an IPO or to sell a small division.”

In one aspect, the innovation prospects investment banking opportunities through text analytics and content analysis as forth above. One example ties all businesses with revenues of between 100 million and 200 million which have made no more than two acquisitions in a predetermined period with all businesses having certain other activities such as, for example, having key employees be keynote speakers at technical conferences. This cross tying here could be a potential indicator of soon-to-be deals. Other factors can be cross-analyzed in order to attempt to forecast a soon to come deal.

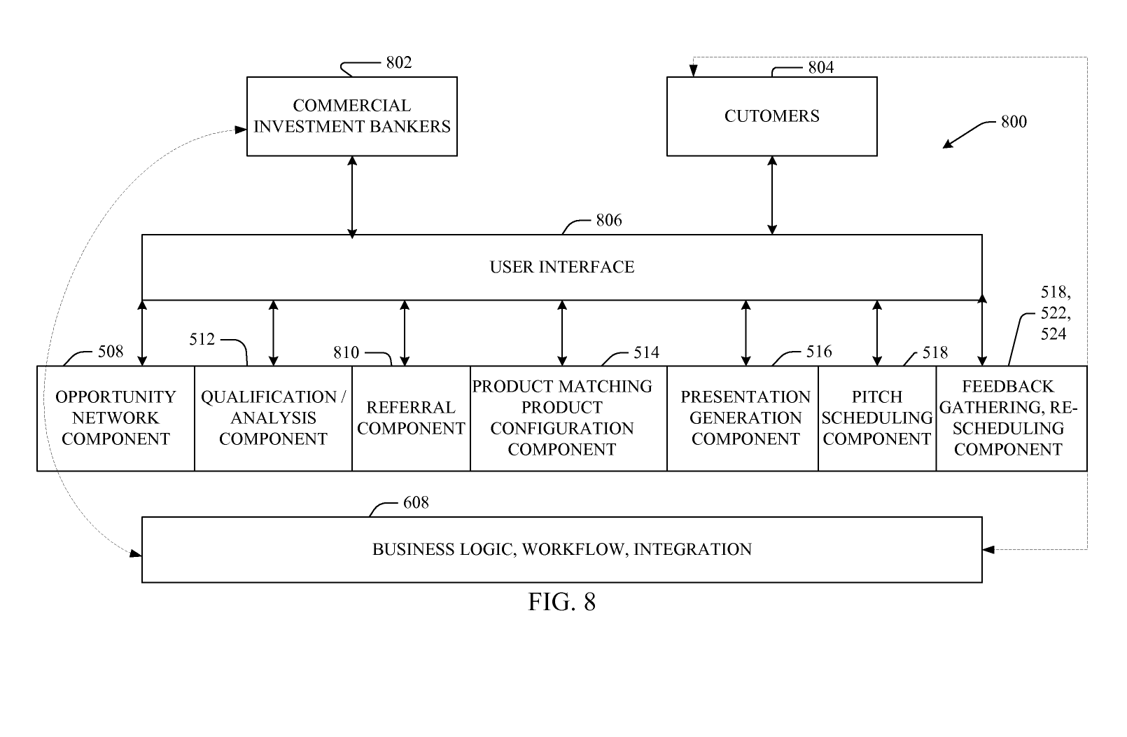

FIG. 8 illustrates a user interface network 800 including users that can be investment bankers (IB) as set fourth at 802 and/or customers as set forth at 804. Both the users that are IBs 802 and the customers 804 have access to a user-interface 804 that facilitates the capturing of opportunities/leads, facilitates qualifying and analyzing the received leads and opportunities, and includes a referral system for referring different leads to different people. Additionally, the user interface facilitates product matching and product configuring. After a product is configured and matched to an opportunity, a presentation is generated. A presentation can then be scheduled to be ‘pitched’ to a customer. After the initial sales pitch, feedback can be gathered, additional information can be gathered, and rescheduling for a second sales pitch can be made if it is desirable to both parties. As illustrated in FIG. 8, several components can be merged into a single component, for example, act 518 where a presentation was scheduled with a potential customer, act 522 where following up was done, and act 524 where feedback was gathered is done with a feedback gathering re-scheduling component 518, 522, 524. A referral component 810 can directly or indirectly refer potential deals to the opportunity network component 508. In one aspect the referrals are passed through the analysis component that qualifies the referral to a defined or preferred standard.

As will be appreciated, user interface network 800 facilitates not having to say no to customers just because they are relatively small. Rather, if desired the small users can be referred to other providers of financial services. Whether the decision is to develop a deal with a customer or to refer the customer to another financial services provider, either way a follow-up occurs. Accordingly, in most aspects, no deals become dropped. Additionally user interface 806 includes increased efficiencies such that smaller deals are retained, the ‘smaller’ deals are usually the ones that would have been referred in the past but now with increased efficiency from the herein described methods and apparatus, the smaller deals are retained.

It will be understood that informed retention of deals, regardless of size, can increase the efficiency ratio (e.g., profit margin). For instance, by retaining smaller deals, the contractual network is extended enhancing the ability to learn of the more additional market opportunities and referrals. Some benefits of the methods and apparatus herein described are the generation of revenue from additional deals and risk mitigation from having several analysis layers. The innovation also mitigates risk in that once the herein described methods and apparatus are operational at a financial institution, inertia will maintain them operational is spite of intellectual capital loss due to attrition or turnover. The system can also provide reduction in execution risk by delivering the ability to track/monitor each step of the deal process.

While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. A client initiates a connection with the server, via sending a logon data stream on the network, for example (e.g., initiating a hand shake). Such communication from the client to the server can contain multiple commands, and a response from the server can return a plurality of result sets.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

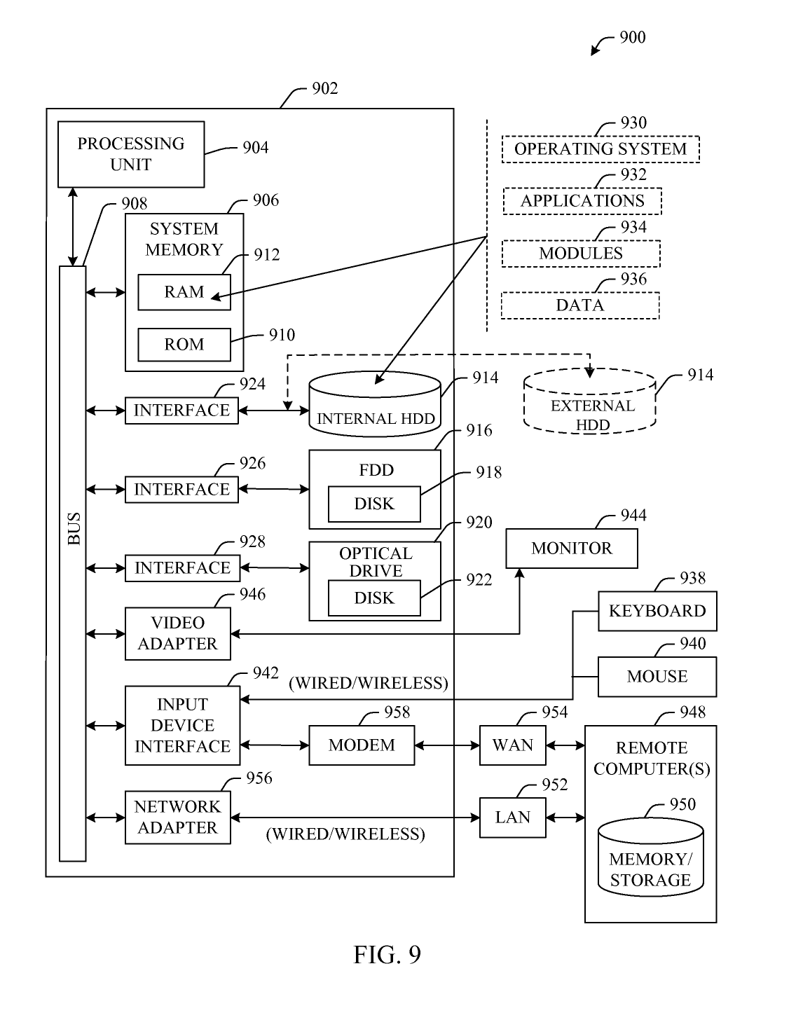

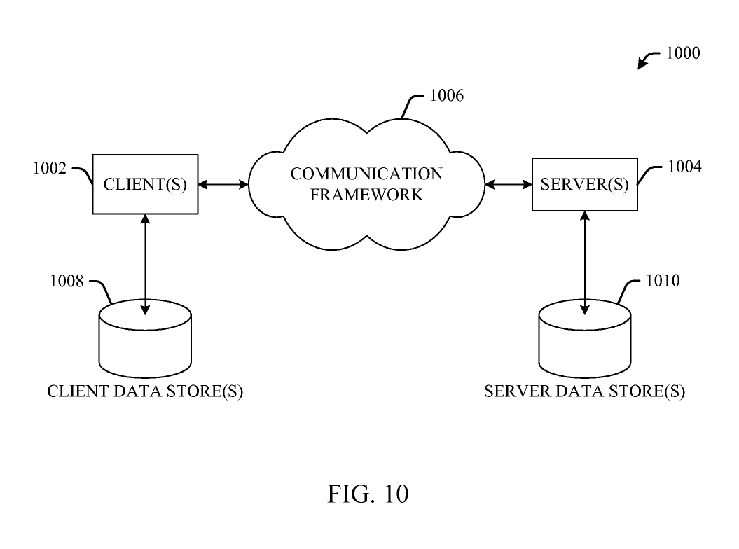

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed for IB Opportunity matching. The system 1000 includes one or more client(s) 1002. The client(s) 1002 can be hardware and/or software (e.g., threads, processes, computing devices). The system 1000 also includes one or more server(s) 1004. The server(s) 1004 can also be hardware and/or software (e.g., threads, processes, computing devices). The servers 1004 can house threads to perform transformations by employing the components described herein, for example. One possible communication between a client 1002 and a server 1004 may be in the form of a data packet adapted to be transmitted between two or more computer processes. The system 1000 includes a communication framework 1006 that can be employed to facilitate communications between the client(s) 1002 and the server(s) 1004. The client(s) 1002 are operatively connected to one or more client data store(s) 1008 that can be employed to store information local to the client(s) 1002. Similarly, the server(s) 1004 are operatively connected to one or more server data store(s) 1010 that can be employed to store information local to the servers 1004.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising the following computer executable components:
a potential opportunity identifier component that discovers a plurality of investment opportunities; and
an opportunity network component that receives a subset of the investment opportunities and matches at least some of the subset to an investment product.

2. The computer implemented system of claim 1 further comprising a filter component that filters the subset of the investment opportunities from the plurality of investment opportunities.

3. The computer implemented system of claim 2 further comprising a matching component that matches each of the subset to the investment product as a function of a predefined policy.

4. The computer implemented system of claim 3 further comprising a product configuring component that configures at least one investment product to best match at least one of the subset of the investment opportunities.

5. The computer implemented system of claim 1 further comprising an investment banking opportunity referral component.

6. The computer implemented system of claim 1 further comprising a product configuration component that configures at least one investment product to best match an investment opportunity.

7. The computer implemented system of claim 1 further comprising a prioritized potential opportunity component to prioritize the subset of the investment opportunities.

8. The computer implemented system of claim 1 further comprising a presentation generation component that creates an individualized sales document for the matches.

9. The computer implemented system of claim 8 further comprising a filter component that filters the subset of the investment opportunities from the plurality of the investment opportunities based upon at least one of size of market, size of company, sector of economy, type of industry, historical sales data, sales forecasts or location.

10. The computer implemented system of claim 1 further comprising a matching component that matches each of the subset of the investment opportunities with a plurality of investment products based upon at least one of size of market, size of company, sector of economy, type of industry, historical sales data, sales forecasts or location.

11. The computer implemented system of claim 10 further comprising a presentation generation component that creates an individualized sales document for the matches.

12. A computer implemented method comprising the following computer executable acts:
receiving information regarding a potential investment banking opportunity; and
at least one of, matching the potential investment banking opportunity with an already established investment product or configuring a new investment product to at least partially match the received potential commercial investment opportunity.

13. The computer implemented method of claim 12 further comprising:
receiving a second potential investment banking opportunity; and
prioritizing the potential investment banking opportunities based upon at least one of size, industry, location, type, or history.

14. The computer implemented method of claim 13 wherein the act of receiving information regarding a potential investment banking opportunity comprises receiving information regarding a filtered list of potential investment banking opportunities.

15. The computer implemented method of claim 13 wherein the act of receiving information regarding a potential investment banking opportunity comprises receiving information regarding a filtered and prioritized list of potential investment banking opportunities.

16. The computer implemented method of claim 13 wherein the act of receiving information regarding a potential investment banking opportunity comprises receiving information regarding a filtered, prioritized and encrypted list of potential investment banking opportunities.

17. The computer implemented method of claim 13 further comprising generating a presentation based upon the matched potential banking opportunity in view of a subset of the investment products.

18. The computer implemented method of claim 17 further comprising reviewing the presentation to determine an error or area for improvement.

19. The computer implemented method of claim 18 further comprising internally correcting the determined error or area for improvement.

20. A computer implemented system comprising the following computer executable components:
means for identifying a plurality of potential investor baking opportunities; and
means for matching a subset of the identified potential investment banking opportunities with at least one investment banking product based upon at least two of size, industry, location and type.
